(19) United States
(12) Patent Application Publication
(10) Pub. No.: US 2025/0150148 A1
(43) Pub. Date: May 8, 2025

(54) BEAM MANAGEMENT IN AN INACTIVE STATE

(71) Applicant: Lenovo (Singapore) Pte. Limited, Singapore (SG)

(72) Inventors: Joachim Löhr, Wiesbaden (DE); Alexander Golitschek Edler von Elbwart, Darmstadt (DE); Prateek Basu Mallick, Dreieich (DE); Hyung-Nam Choi, Ottobrunn (DE); Ravi Kuchibhotla, Chicago, IL (US)

(73) Assignee: Lenovo (Singapore) Pte. Limited, Singapore (SG)

(21) Appl. No.: 18/730,232

(22) PCT Filed: Jan. 13, 2023
(86) PCT No.: PCT/IB2023/050341

§ 371 Date: Jul. 18, 2024

Related U.S. Application Data
(60) Provisional application No. 63/300,903, filed on Jan. 19, 2022.

(51) Int. Cl. H04B 7/06; H04B 17/318; H04W 68/02

(52) U.S. Cl. CPC H04B 7/06952; H04B 17/328; H04W 68/02

(57) ABSTRACT

Various aspects of the present disclosure relate to a user equipment (UE) that performs beam management while in a radio resource control inactive (RRC_INACTIVE) state. In one or more implementations, while in the RRC_INACTIVE state, the UE triggers generation of beam information for a base station. This beam information indicates a new serving beam on which, for example, a paging message is to be received from the base station. The UE generates and transmits the beam information to the base station.

### RELATED APPLICATION

This application claims priority to U.S. Patent Application Ser. No. 63/300,903 filed Jan. 19, 2022 entitled “Beam Management in an Inactive State,” the disclosure of which is incorporated by reference herein in its entirety.

### TECHNICAL FIELD

The present disclosure relates to wireless communications, and more specifically to beam management in an inactive state.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, subslots, slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G.

New radio (NR) supports an inactive state referred to as radio resource control (RRC) inactive (RRC_INACTIVE). UEs with infrequent (periodic and/or non-periodic) data transmission are generally maintained by the network in the RRC_INACTIVE state. In order to transmit data to or receive data from a base station, the UE resumes the connection with the network (i.e., moves to an RRC connected (RRC_CONNECTED) state). Connection setup and subsequent release to RRC_INACTIVE state happens for each data transmission however small and infrequent the data packets are.

In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances. In a positioning system for an NTN, one or more location servers, or components of the location servers, may communicate with one or multiple UEs connected to the NTN over a wireless medium. In some cases, the propagation delays in an NTN can be orders of magnitude longer than those in a typical terrestrial network (TN). Additionally, satellites or any other non-terrestrial transmit-receive points (NT-TRPs), may be moving at high speeds, for example in the case of low-earth orbit (LEO) and medium-earth orbit (MEO) satellite systems. Other non-terrestrial systems, such as geosynchronous satellite systems, may also introduce wireless communication challenges due to NT-TRP movements.

### SUMMARY

The present disclosure relates to methods, apparatuses, and systems that enable a communication device (e.g., a UE, a base station, a network entity) to perform beam management while in the RRC_INACTIVE state. In one or more implementations, while in the RRC_INACTIVE state, the UE triggers generation of beam information for a base station. This beam information indicates a new serving beam on which, for example, a paging message is to be received from the base station. The UE generates and transmits the beam information to the base station as part of a small data transmission (SDT).

Some implementations of the method and apparatuses described herein may further include wireless communication at a device (e.g., at a UE), which includes triggering generation of beam information for a base station, the beam information indicating a new serving beam; generating the beam information; and transmitting the beam information to the base station as part of an SDT session.

In some implementations of the method and apparatuses described herein, the new serving beam comprising a serving beam on which a paging message is to be received from the base station. Additionally or alternatively, the method and apparatuses described herein determine to trigger generation of the beam information in response to a current serving beam for receiving paging messages from the base station having changed. Additionally or alternatively, transmitting the beam information to the base station is transmitting the beam information to the base station using an uplink (UL) of the SDT session. Additionally or alternatively, the method and apparatuses described herein detect that the current serving beam has changed by measuring a reference signal received power (RSRP) of a most recently received synchronization signal block (SSB) of the current serving beam, comparing the RSRP of the most recently received SSB to the RSRP of an immediately previous most recently received SSB of the current serving beam, and detecting that the current serving beam has changed if the RSRP of the most recently received SSB is at least a threshold amount less than the RSRP of the immediately previous most recently received SSB. Additionally or alternatively, the method and apparatuses described herein detect the change by measuring one or more reference signals (RSs) prior to monitoring a physical downlink control channel (PDCCH) addressed to a paging radio network temporary identifier (P-RNTI) within a control resource set (CORESET) at a paging occasion (PO) defined for the apparatus. Additionally or alternatively, method and apparatuses described herein receive a request from the base station for the beam information, and wherein to trigger generation of the beam information is to trigger generation and transmission of the beam information in response to the request from the base station. Additionally or alternatively, the request from the base station is a request for the apparatus to initiate a random access channel (RACH) procedure, and wherein to transmit the beam information is to transmit the beam information to the base station as part of a RACH SDT session. Additionally or alternatively, the beam information comprises geographic location information. Additionally or alternatively, the beam information includes a channel state information reference signal (CSI-RS) index of the new serving beam. Additionally or alternatively, the beam information includes an SSB index of the new serving beam. Additionally or alternatively, the method and apparatuses described herein initiate, in response to triggering generation of the beam information or in response to generating the beam information, the SDT session.

Some implementations of the method and apparatuses described herein may further include wireless communication at a device (e.g., at a base station), which includes receiving beam information from a UE while the UE is in an RRC_INACTIVE state, the beam information indicating a new serving beam; and using the beam information for subsequent transmissions to the user equipment.

In some implementations of the method and apparatuses described herein, the method and apparatuses described herein receive the beam information from the UE is to receive the beam information from the UE using a UL of an SDT session. Additionally or alternatively, the method and apparatuses described herein transmit, to the UE, a request for the UE to generate the beam information, and wherein to receive the beam information is to receive the beam information from the UE in response to the request. Additionally or alternatively, the request is a request for the UE to initiate a RACH procedure, and wherein to receive the beam information is to receive the beam information from the UE as part of a RACH SDT session. Additionally or alternatively, the beam information includes geographic location information. Additionally or alternatively, the beam information includes a CSI-RS index of the new serving beam. Additionally or alternatively, the beam information includes an SSB index of the new serving beam.

### BRIEF DESCRIPTION OF THE DRAWINGS

Various aspects of the present disclosure for beam management in an inactive state are described with reference to the following Figures. The same numbers may be used throughout to reference like features and components shown in the Figures.

FIG. 1 illustrates an example of a wireless communications system that supports beam management in an inactive state in accordance with aspects of the present disclosure.

FIG. 2 illustrates an example of resuming a connected state to transmit data between a UE and a base station.

FIG. 3 illustrates an example of resuming configured grant (CG) based SDT in the RRC_INACTIVE state.

FIG. 4 illustrates an example of resuming RACH based in the RRC_INACTIVE state.

FIG. 5 illustrates an example of a block diagram of a device that supports beam management in an inactive state in accordance with aspects of the present disclosure.

FIG. 6 illustrates an example of a block diagram of a device that supports beam management in an inactive state in accordance with aspects of the present disclosure.

FIGS. 7, 8, 9, 10, and 11 illustrate flowcharts of methods that support beam management in an inactive state in accordance with aspects of the present disclosure.

### DETAILED DESCRIPTION

Implementations of beam management in an inactive state are described, such as related to a wireless system that supports SDT sessions while the UE is in an RRC_INACTIVE state. The RRC_INACTIVE state is a lower power state than the RRC_CONNECTED state but a higher power state than an RRC idle (RRC_IDLE) state. The RRC_INACTIVE state allows the UE to save some power but also allows for transitioning to the RRC_CONNECTED state quicker than when coming from the RRC_IDLE state. An SDT session can be established while the wireless system is in the RRC_INACTIVE state. The SDT session allows some data to be transferred between the UE and the base station without needing the UE to transition to the RRC_CONNECTED state.

The UE performs beam management while in the RRC_INACTIVE state. Beam management refers to various aspects of selecting a beam to use to transmit data between the UE and a base station, such as checking whether a current serving beam needs to be changed, identifying one or more candidate beams, transmitting beam information identifying a new serving beam to the base station, and so forth.

The present disclosure relates to methods, apparatuses, and systems that enable a communication device (e.g., a UE, a base station, a network entity) to perform beam management while in the RRC_INACTIVE state. In one or more implementations, while in the RRC_INACTIVE state, the UE triggers generation of beam information for a base station. This beam information indicates a new serving beam on which, for example, a paging message is to be received from the base station. The UE generates and transmits the beam information to the base station.

The UE can trigger generation of the beam information in any of various manners. In one or more implementations, the UE triggers generation of the beam information in response to determining that a current serving beam has changed since beam information was last transmitted to the base station. This change can be detected by the UE by, for example, comparing the RSRP of a SSB most recently received from the base station to the RSRP of the SSB at the time the beam information was last transmitted to the base station. Additionally or alternatively, the UE triggers generation of the beam information in response to a request from the base station for the beam information.

When a base station receives downlink (DL) data for a UE from a user plane function (UPF), the base station triggers a mobile terminated (MT) SDT (MT-SDT) session in order to transmit the DL data to the concerned UE in the RRC_INACTIVE state by sending a paging message. In higher frequency ranges (e.g., frequency range 2 (FR2)) the NR cell coverage may be provided by multiple beams where each beam has a narrow coverage. Due to the limited spatial coverage with each beam, the broadcast transmission of paging in NR is performed using beam sweeping, which takes multiple time slots. Thus, the paging procedure used in NR would substantially increase the DL resource overhead of the network with directional transmissions. In a directional NR system, a base station covers the entire cell by transmitting the same paging message over all the supported beams via beam-sweeping.

Using the techniques discussed herein, the UE provides beam information to the base station while being in the RRC_INACTIVE state. Based on the provided beam information the base station is able to perform paging transmissions only over a subset of all transmission beams. By reducing the number of transmission beams over which the paging transmissions are performed, the amount of network resources needed for paging the UE is reduced.

Furthermore, by providing the beam information to the base station while the UE is in the RRC_INACTIVE state, the UE conserves power by remaining in the RRC_INACTIVE state rather than transitioning to the RRC_CONNECTED state to generate and transmit the beam information to the base station.

Additionally, in one or more implementations the techniques discussed herein can be used to identify solutions that allow for efficient beam management during an SDT session. The UE can send beam information to the base station during an SDT session, allowing the UE to avoid situations where the quality of one or more beams being used for the transmission of data and/or control degrades and link reliability cannot be ensured anymore.

Aspects of the present disclosure are described in the context of a wireless communications system. Aspects of the present disclosure are further illustrated and described with reference to device diagrams and flowcharts that relate to beam management in an inactive state.

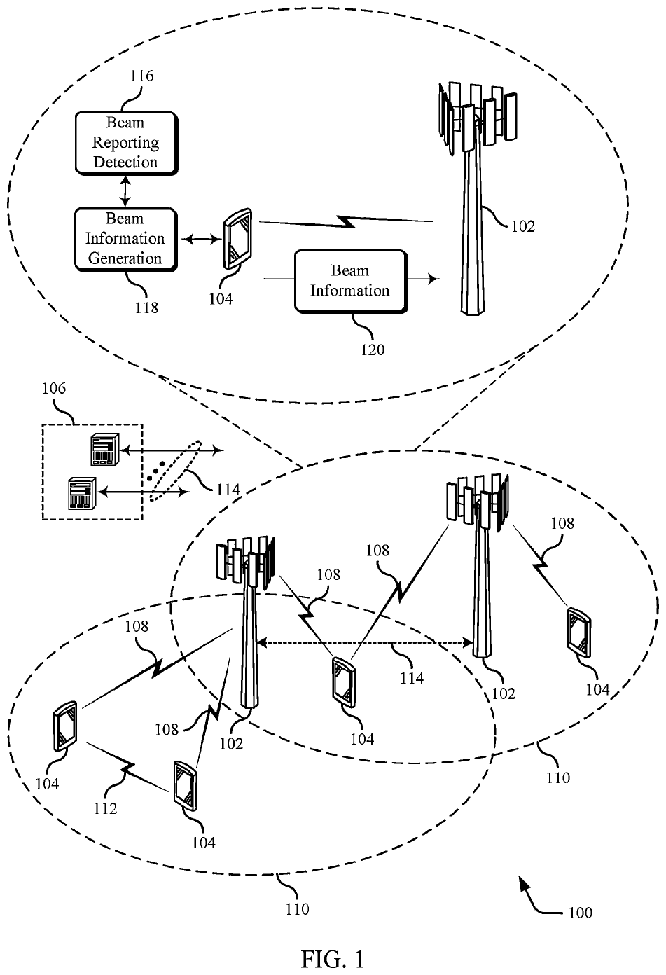

FIG. 1 illustrates an example of a wireless communications system 100 that supports beam management in an inactive state in accordance with aspects of the present disclosure. The wireless communications system 100 may include one or more base stations 102, one or more UEs 104, and a core network 106. The wireless communications system 100 may support various RATs. In some implementations, the wireless communications system 100 may be a 4G network, such as an LTE network or an LTE-A network. In some other implementations, the wireless communications system 100 may be a 5G network, such as a NR network. In other implementations, the wireless communications system 100 may be a combination of a 4G network and a 5G network. The wireless communications system 100 may support RATs beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNB, a gNB, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UE 104 within the geographic coverage area 110. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite associated with an NTN. In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment, a subscriber device, or some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100, such as a very small aperture terminal (VSAT), which may be connected to one or multiple other network nodes serving other UEs. In other implementations, a UE 104 may be mobile in the wireless communications system 100.

The one or more UEs 104 may be devices in different forms or having different capabilities. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 114 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, TRPs, and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a UPF). In some implementations, the control plane entity may manage non-access stratum (NAS) functions, such as mobility, authentication, and bearer management for the one or more UEs 104 served by the one or more base stations 102 associated with the core network 106.

According to implementations for beam management in an inactive state a UE 104 can identify, while in the RRC_INACTIVE state, beams to use for receiving paging messages from a base station 102. For instance, in the wireless communications system 100, the UE 104 performs beam reporting detection 116 to determine when beam information is to be reported to the base station 102. The UE 104 performs beam reporting detection 116 in any of a variety of manners as discussed in more detail below.

The UE 104 performs beam information generation 118 on one or more beams received from the base station 102. As part of the beam information generation 118, for example, the UE 104 measures different attributes of the one or more beams received from the base station 102, such as RSRP, reference signal received quality (RSRQ), received signal strength indicator (RSSI), signal-to-interference and noise ratio (SINR), and so forth, to determine measurements for the one or more beams. Additionally or alternatively, as part of the beam information generation the UE 104 uses geographic location information for the UE 104.

The UE 104 communicates the beam information 120 to the base station 102 and the UE 104 receives wireless paging messages from the base station 102 utilizing one or more beams identified in the beam information 120.

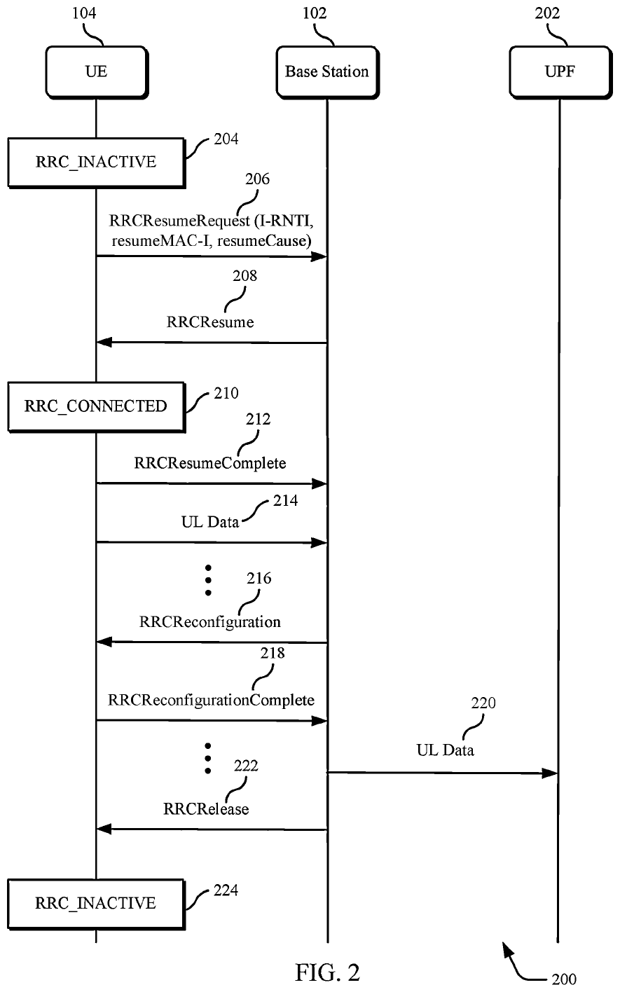

FIG. 2 illustrates an example 200 of resuming a connected state to transmit data between a UE and a base station. The example 200 illustrates communication involving the UE 104, a base station 102, and a user plane function (UPF) 202.

At 204, the UE 104 is in the RRC_INACTIVE state.

At 206, the UE 104 transmits an RRCResumeRequest to the base station 102 to resume the connected state. The RRCResumeRequest includes an inactive-radio network temporary identifier (I-RNTI) parameter, an Authentication token to facilitate UE authentication at the base station 102 (resumeMAC-I) parameter, and a cause parameter (resumeCause).

At 208, the base station 102 transmits a RRCResume response indicating to the UE 104 to enter the RRC_CONNECTED state.

At 210, the UE 104 enters the RRC_CONNECTED state.

At 212, the UE 104 transmits an RRCResumeComplete indication to the base station 102 notifying the base station 102 that the UE 104 has entered the RRC_CONNECTED state.

At 214, the UE 104 transmits UL data to the base station 102.

At 216, the base station 102 communicates an RRCReconfiguration indication to the UE 104 notifying the UE 104 to modify the RRC connection, e.g. to establish/modify/release radio bearers (RBs), to perform reconfiguration with sync, to setup/modify/release measurements, and to add/modify/release secondary cells (SCells) and cell groups.

At 218, the UE 104 transmits an RRCReconfiguration Complete indication to the base station 102 notifying the base station that the UE 104 has received and executed the RRCReconfiguration message.

At 220, the base station 102 transmits the data received from the UE 104 to the UPF 202.

At 222, the base station 102 transmits an RRCRelease indication to the UE 104 notifying the UE 104 that the UE 104 can return to the RRC_INACTIVE state.

At 224, the UE 104 enters the RRC_INACTIVE state.

The example 200 results in unnecessary power consumption and signaling overhead, particularly in situations in which the amount of UL data at 214 is relatively small. For example, the UL data at 214 may be only two or three Transport Blocks. Accordingly, SDTs can be used to transmit data between the UE 104 and base station 102.

In one or more implementations, for SDT while the UE 104 is in the RRC_INACTIVE state, for a RACH, e.g., 2-step or 4-step RACH, the following applies: 1) a general procedure to enable UP data transmission for small data packets from the RRC_INACTIVE state is supported (e.g. using MSGA or MSG3 in 4-step RACH); 2) flexible payload sizes larger than the Rel-16 common control channels (CCCH) message size that is possible for the RRC_INACTIVE state for MSGA and MSG3 is enabled to support UP data transmission in UL (the actual payload size can be up to network configuration); and 3) context fetch and data forwarding (with and without anchor relocation) in the RRC_INACTIVE state for RACH-based solutions is supported.

In one or more implementations, for SDT while the UE 104 is in the RRC_INACTIVE state, for transmission of UL data on pre-configured physical uplink shared channel (PUSCH) resources (e.g., reusing the configured grant type 1), when time alignment (TA) is valid, the following applies: 1) a general procedure for small data transmission over configured grant type 1 resources from the RRC_INACTIVE state is supported; and 2) configuration of the configured grant type1 resources for small data transmission in UL for the RRC_INACTIVE state is supported.

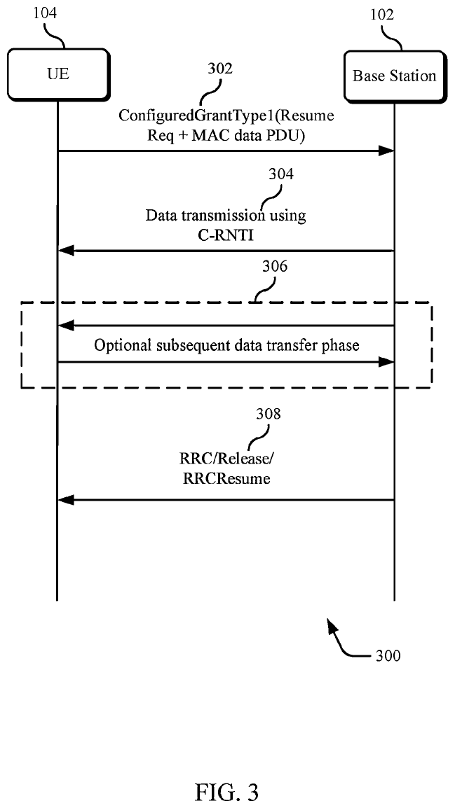

FIG. 3 illustrates an example 300 of resuming CG based SDT in the RRC_INACTIVE state. The example 300 illustrates communication involving the UE 104 and a base station 102.

At 302, the UE 104 transmits the initial SDT message, e.g., a RRCResumeRequest message and optionally some UL data, to the base station 102 to initiate an SDT session. The initial SDT message is transmitted on the pre-allocated resources, e.g., ConfiguredGrant type 1 resources (CG PUSCH resources). The initial SDT message includes as parameters a request to Resume the RRC connection (Resume Req), and UL data which are transmitted as medium access control (MAC) protocol data unit (PDU) data (MAC data PDU).

At 304, the base station 102 sends a data transmission to the UE 104 using cell-radio network temporary identifier (C-RNTI).

At 306, one or more data transmissions are optionally made from the UE 104 to the base station 102, or from the base station 102 to the UE 104.

At 308, the base station 102 transmits an RRCRelease or RRCResume indication to the UE 104 notifying the UE 104 that the SDT session has ended.

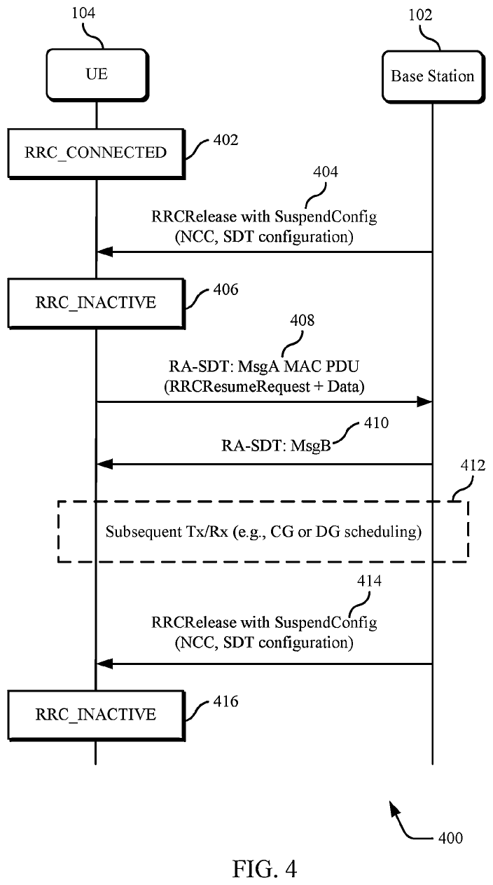

FIG. 4 illustrates an example 400 of resuming RACH based SDT in the RRC_INACTIVE state. The example 400 illustrates communication involving the UE 104 and a base station 102.

At 402, the UE 104 is in the RRC_CONNECTED state.

At 404, the base station 102 transmits an RRCRelease with SuspendConfig indication to the UE 104. The RRCRelease with SuspendConfig indication notifies the UE 104 to enter the RRC_INACTIVE state.

At 406, the UE 104 is in the RRC_INACTIVE state.

At 408, the UE 104 transmits an RA-SDT message to the base station 102. The RA-SDT message is a physical random access channel (PRACH) preamble or a PRACH preamble and some uplink data transmission, e.g. msgA in a 2-step RACH procedure. The UL data transmission, e.g. msga-PUSCH contains the RRCResumeRequest message and optionally some UL data.

At 410, the base station 102 transmits an Rach Response message to the UE 104. In a 2-step RACH procedure the response message is a MsgB message.

At 412, one or more data transmissions are optionally made from the UE 104 to the base station 102, or from the base station 102 to the UE 104. These are done, for example, using CG or dynamic grant (DG) scheduling.

At 414, the base station 102 transmits an RRCRelease with SuspendConfig indication to the UE 104. The RRCRelease with SuspendConfig indication notifies the UE 104 to enter the RRC_INACTIVE state.

At 416, the UE 104 is in the RRC_INACTIVE state.

In one or more implementations, for SDT while the UE 104 is in the RRC_INACTIVE state, paging-triggered SDT (also referred to as MT-SDT is supported. In such implementations, the following applies: 1) MT-SDT triggering mechanism for UEs 104 in the RRC_INACTIVE state, with random access SDT (RA-SDT) and CG SDT (also referred to as CG-SDT) as the UL response are supported; and 2) MT-SDT procedure for initial DL data reception and subsequent UL/DL data transmissions in the RRC_INACTIVE state are supported. For UL SDT the change of a beam, i.e. the beam which is selected by the UE 104 for the reception/transmission of control/data, could be implicitly indicated by CG-PUSCH resources selected (e.g., using SSB-CG-PUSCH mapping). During the subsequent new CG transmission phase, for the purpose of CG resource selection, UE re-evaluates the SSB for subsequent CG transmission.

In one or more implementations, for SDT while the UE 104 is in the RRC_INACTIVE state, the following applies:
1. For small data, for RACH and CG based solutions when the UE 104 receives RRC release with Suspend config, the UE 104 at least performs the following actions (i.e. same action as in legacy): MAC is reset and default MAC cell group configuration is released, radio link control (RLC) entities for signalling radio bearer (SRB) 1 (SRB1) are re-established, SRBs and data radio bearers (DRBs) are suspended except SRB0.
2. For both RACH and CG based solutions, upon initiating RESUME procedure for SDT initiation (i.e. for first SDT transmission), the UE 104 shall re-establish at least the SDT packet data convergence protocol (PDCP) entities and resume the SDT DRBs that are configured for small data transmission (along with the SRB1).
3. The first UL message (i.e. MSG3 for 4-step RACH, MSGA payload for 2-step RACH and the CG transmission for CG) may contain at least the following contents (depending on the size of the message): CCCH message. Logical channel prioritization procedure (LCP) can be used to determine priority of the following content that may be included: DRB data from one or more DRBs which are configured by the network for small data transmission; MAC CEs (e.g. buffer status reporting (BSR)); padding bits.
4. For RACH and CG, the existing unified access control (UAC) procedure to determine whether access attempt is allowed, will be reused for SDT.
5. SDT is transparent to the non-access stratum (NAS) layer (i.e. NAS generates one of the existing resume causes and AS decides SDT vs non-SDT access).
6. In case of RRC-based solution, for both RACH and CG based solutions, the CCCH message contains ResumeMAC-I generated using the stored security key for RRC integrity protection—i.e. same as Rel-16.
7. For both RACH and CG based solutions, new keys are generated using the stored security context and the Next Hop Chaining Counter (NCC) value received in the previous RRCRelease message (i.e. same as legacy procedure) and these new keys are used for generating the data of DRBs that are configured for SDT.
8. For RACH based solutions, upon successful completion of contention resolution, the UE shall monitor the C-RNTI.
9. As a baseline, the RACH resource i.e. (RACH occasion (RO)+preamble combination) is different between SDT and non-SDT. If ROs for SDT and non SDT are different, preamble partitioning between SDT and non SDT is not needed. If ROs for SDT and non SDT are same, preamble partitioning is needed.
10. If the RACH resource i.e. (RO+preamble combination) is different between SDT and non-SDT then there is no further need for any differentiation between MSG2/MSGB for SDT vs non-SDT

In one or more implementations, for SDT while the UE 104 is in the RRC_INACTIVE state, the following applies:
1. The configuration of CG resource for UE UL SDT is contained in the RRCRelease message. Configuration is only type 1 CG with no contention resolution procedure for CG.
2. The configuration of CG resource can include one type 1 CG configuration.
3. A new TA timer for TA maintenance specified for CG based SDT in RRC_INACTIVE is introduced. The TA timer is configured together with the CG configuration in the RRCRelease message.
4. The configuration of CG resource for UE SDT is valid only in the same serving cell.
5. The UE can use CG based SDT if at least the following criteria is fulfilled: (a) user data is smaller than the data volume threshold; (b) CG resource is configured and valid; and (c) UE has valid TA.
6. An association between CG resources and SSBs is made for CG-based SDT.
7. A synchronization signal reference signal received power (SS-RSRP) threshold is configured for SSB selection. UE selects one of the SSB with SS-RSRP above the threshold and selects the associated CG resource for UL data transmission.

In one or more implementations, for SDT while the UE 104 is in the RRC_INACTIVE state, the following applies:
1. The Rel-16 CG configuration mechanism in licensed band is reused the baseline for CG-SDT.
2. At least for initial transmission use a mechanism to allow the UE to transmit the message again.
3. The UE uses/selects the same hybrid automatic repeat request (HARQ) process for retransmission.
4. The “CG-SDT timer” starts at the first “valid” PDCCH occasion from the end of the CG-SDT PUSCH transmission.
5. The “CG-SDT timer” can be started/restarted during for initial and subsequent transmissions.
6. The UE restarts the “CG-SDT timer” at least: upon the PUSCH retransmission indicated by the configured scheduling radio network temporary identifier (CS-RNTI) PDCCH, and after each CG-SDT transmission.
7. The “CG-SDT timer” stops at least when the UE receives RRC feedback messages (e.g. RRCResume, RRCSetup, RRCRelease and RRCReject).
8. The Rel-16 calculation on the HARQ process ID of the CG type-1 for licensed band is reused as the baseline for CG-SDT.
9. The UE is allowed to initiate subsequent UL data transmission only after the reception of confirmation of initial transmission from the base station.
10. The UE can use multiple CG resources for the HARQ initial transmission as Rel-16 in the subsequent CG transmission phase.
11. The following CG-SDT configurations are per UE: the new TA timer in RRC_INACTIVE, the RSRP change threshold for TA validation mechanism in SDT, the SSB RSRP threshold for beam selection.

In case of low/mid frequency region without using massive antenna array, a single transmission would cover multiple UEs 104 simultaneously. However, when the radiation becomes beam-shaped, e.g., in high frequency bands like FR2, it is very difficult to cover multiple UEs 104 in a single transmission unless those multiple UEs 104 are located in very close proximity. As the carrier frequency is increasing, the propagation gets more challenging as the pathloss between transmitter and receiver is increasing due to the assumption of a fixed antenna size relative to the wavelength. Further, beyond 10 Ghz reflections and scattering will be the most important propagation mechanism for non-line-of-sight (NLOS) communication. To handle this problem, the beam is managed/controlled to cover the multiple devices scattered in all directions and the management/control mechanism can be different depending on the situations. Beam management is understood as a set of Layer 1 and Layer 2 procedures to acquire and maintain a set of beams at both transmitter and receiver which are used for the transmission of control and data channels. Beam management consists of a set of procedures which are valid for both the base station 102 and the UE 104:
1. Beam determination is performed first by both transmitter and receiver. This implies identification of best beam for transmission and reception of data, e.g. as an outcome of the beam sweeping procedure. A concept of this procedure is the beam correspondence.
2. Beam measurement implies obtaining the characteristics, e.g. power, of the received beamformed signals.
3. Beam reporting leads to the transmission of a beam measurement report to the transmitter.

According to legacy 3GPP standards (Rel-16), the UE is providing beam measurements for the purpose of DL/UL beam selection. L1-RSRP measurements are used for that purpose: for DL beam selection; for UL beam and panel selection where the UE would determine reported DL RS indices (together with measurement result and panel identifier).

The network (NW), such as the base station 102 or the core network 106, configures beam (group) reporting for the UE 104, i.e. CSI-RS resource indicator (CRI). The NW configures for which CRIs the UE 104 shall report, e.g. L1-RSRP. In Rel-15 the NW can configure CSI reporting for beam reporting with different types of time periodicities, including periodic, semi-persistent, and aperiodic. The payload sizes of the beam report can vary according to the number of reported and measured CSI resources as well as whether differential or non-differential coding is used. Table I indicates example CSI reporting activations with different CSI-RS configurations.

TABLE I

| | Periodic | | |
|---|---|---|---|
| CSI-RS | CSI | Semi-persistent | Aperiodic CSI |
| configuration | Reporting | CSI reporting | reporting |
| Periodic | No dynamic | For PUCCH based | DCI can activate |
| CSI-RS | activation | reporting, MAC CE | reporting. |
| | | activates. For | Additionally, MAC |
| | | PUSCH based | CE can also active |
| | | reporting, downlink | it. |
| | | control indicator | |
| | | (DCI) activates. | |
| Semi- | Not supported | For PUCCH based | DCI can activate |
| Persistent | | reporting, MAC CE | reporting. |
| CSI-RS | | activates. For | Additionally, MAC |
| | | PUSCH based | CE can also activate |
| | | reporting, DCI | it. |
| | | activates. | |
| Aperiodic | Not supported | Not supported | DCI can activate |
| CSI-RS | | | reporting. |
| | | | Additionally, MAC |
| | | | CE can also activate |
| | | | it. |

To recover from the rapid interruptions of connectivity, an alternative candidate link may exist between the UE 104 and the base station 102 and to re-establish or reconnect the beam failure recovery (BFR) procedure has been specified. In the beam recovery procedure the UE 104 monitors the radio link by estimating the hypothetical quality of the DL control channels based on a set of periodically referenced signals, i.e. beam failure detection reference signal (BFD-RS). When the UE 104 estimates that the quality of the link is not adequate to maintain reliable communication, the UE 104 declares beam failure. The BFD-RS are configured by NW similar to radio link monitoring reference signal (RLM-RS). For BFD-RS only periodic CSI-RS that are quasi-co-located with the PDCCH Demodulation Reference Signal (DM-RS) can be used. The quality of a BFD-RS is compared against a threshold Q_{out_LR}, e.g., 10% block error rate (BLER) of hypothetical PDCCH.

The new candidate beam is selected based on received signal strength, even though the beam failure detection (BFD) metric is based on perceived reception quality (considering also interference). The candidate beam is selected by MAC based on Layer 1 RSRP (L1-RSRP) measurements provided by the physical layer (PHY). If the UE 104 has been configured with candidate beam list, the UE 104 checks first if the L1-RSRP of any of the CFRA candidates is above a configured threshold. If no CFRA candidate, the UE 104 performs contention-based random access (CBRA) based recovery. In CBRA recovery the UE 104 indicates an SSB to the base station 102 by transmitting the corresponding preamble. The CBRA recovery is a normal RACH procedure where the SSB is selected based on L1-RSRP measurements.

In one or more implementations, the UE 104 provides beam information to the base station 102 while being in the RRC_INACTIVE state. In one example, the UE 104 triggers an SDT session (also referred to as an SDT procedure) for the reporting of beam information (also referred to as a beam report) while being in the RRC_INACTIVE state. In order to avoid transitioning to the RRC_CONNECTED state for the transmission of the beam report, the UE 104 initiates an SDT session for the beam information reporting. The beam report may be signaled via a MAC control element (CE) or via higher layer signaling, e.g., RRC signaling. In one or more implementations the MAC layer or PHY informs higher layers such as the RRC layer that beam information has been generated. In response to this notification, the RRC layer initiates an SDT session.

In one or more implementations for the SDT session, the MAC entity also considers MAC CEs for the SDT data volume calculation. In addition to buffered packets in PDCP/RLC entities, the MAC CEs are also counted in the SDT data volume calculation. The MAC layer checks whether the data volume of the pending UL data across all radio bearers (RBs) configured for SDT as well as MAC CEs pending in the UE 104 for transmission is less than or equal to a configured threshold amount (e.g., the sdt-Data VolumeThreshold value) in order to determine whether to start an SDT session. If the data volume is less than or equal to the threshold amount, the MAC layer or PHY layer informs a higher layer (e.g., the RRC layer) to initiate an SDT session. If the data volume is higher than the threshold amount, the MAC layer or PHY layer informs a higher layer (e.g., the RRC layer) to initiate returning to the RRC_CONNECTED state. In other implementations, MAC CEs are not considered for the data volume calculation.

Additionally or alternatively, the SDT is initiated without considering the data volume threshold. For example, the SDT is initiated if other conditions, such as the RSRP value of the downlink pathloss reference is higher than a configured threshold amount (e.g., the sdt-RSRP-Threshold value).

In one or more implementations, the network (e.g., the base station 102) configures the UE 104, indicating to the UE 104 whether the UE 104 is to provide beam information to the network while being in the RRC_INACTIVE state. In one example the configuration is provided within the RRCRelease message, e.g., the SuspendConfig information element includes one or more fields configuring the UE 104 for beam information reporting within the RRC_INACTIVE state. Such beam information reporting may be only suitable or beneficial, for example, for the UE 104s which are considered as rather static UEs 104 (e.g., UEs 104 that do not exhibit a large amount of movement, such as sensors). In one example the UE 104 only reports beam information to the network (e.g., the base station 102) if the UE 104 is configured with CG-SDT resources. Additionally or alternatively, the network (e.g., the base station 102) configures the UE 104 with the RSRP threshold level (sdt-RSRP-Threshold) that is used to determine or select the one or more DL beams that are reported as part of the beam information by the UE 104. In one example the configuration of the RSRP threshold level (sdt-RSRP-Threshold) is provided within the RRCRelease message, e.g., the SuspendConfig information element includes one or more fields with the RSRP threshold level. The UE 104 includes in the beam information, for example, each beam having an RSRP value equal to or greater than the RSRP threshold level.

Based on the provided beam information the base station 102 is able to perform paging transmissions only over a subset of all transmit (Tx) beams (e.g., a set of active beams). In order to identify the set of active beams, some beam information reporting, initiated by the UE 104s in the RRC_INACTIVE state or requested/triggered by the base station 102 is used.

Additionally or alternatively, based on the provided beam information the base station 102 is able to send downlink data to the UE 104 in the RRC_INACTIVE state directly, e.g., PDCCH addressed to C-RNTI of the UE 104, without the need to prior page the UE 104. In such situations it is assumed that the network is aware of the existence of the UE 104 in a cell based on provided beam information and uses this beam information for scheduling the UE 104 directly for DL data transmission without paging the UE 104 in order to start, e.g., a DL SDT session (MT-triggered SDT). In one or more implementations, the UE 104 is configured with a set of periodic resources and/or a CORESET which the UE 104 is to monitor PDCCH for DL transmissions on. For example, the UE 104 may be provided such CORESET configuration/resource configuration within the RRCRelease message. The network (e.g., the base station 102) may transmit DL data (PDCCH/physical downlink user data channel (PDSCH)) to the UE 104 on those configured resources/CORESET using only a subset of all Tx beams based on the provided beam information.

In one or more implementations, the UE 104 in the RRC_INACTIVE state measures the quality, e.g., RSRP or reference signal received quality (RSRQ), of the DL Tx beams which are used for receiving a paging downlink control indicator (DCI), i.e., PDCCH addressed to the paging RNTI (P-RNTI) or the corresponding PDSCH carrying the paging message (record). In one example the UE 104 measures and selects the beam based on SSBs sent prior to a PO. In each PO, paging DCI transmissions by the base station 102 are performed over all the supported DL Tx beams. The UE 104 determines the DL Tx beam over which it would receive the paging DCI/paging message (e.g., the beam having the highest RSRP or RSRQ). Thus, beam searching is incorporated in directional operations. The UE 104 can use SSBs transmitted by the base station 102 over all the supported DL Tx beams, where the UE 104 can wake up before its PO and measures the signal quality of SSBs from each of the base station 102's Tx beams to determine the best DL Tx beam(s). In one example, the UE 104 considers only beams where it expects transmission of a DCI scrambled with P-RNTI or inactive RNTI (I-RNTI), e.g., where it is configured with a CORESET including a search space for Type2-PDCCH.

In one or more implementations, in order to reduce the UE 104 power consumption for the reporting of the paging beam information certain trigger conditions for the beam reporting are defined. In one example if the DL Tx beam used for receiving paging has changed compared to the last used DL Tx beam, the UE 104 provides new candidate beam information to the base station 102 by initiating an SDT session. In another example, the UE 104 reports new beam information if the RSRP of the last used Tx beam (e.g., the RSRP of the SSB of the last used Tx beam) dropped by more than a preconfigured threshold (e.g., a particular number of decibels (dB), such as 10 dB) since the Tx beam was last used. This threshold may be provided in the RRCRelease message, e.g. a SuspendConfig information element. In one implementation the UE 104 is configured with a predefined paging group, which is used in order to select the UE 104s which are reporting beam information for allowing the base station 102 to transmit paging DCI/PDSCH only over a subset of Tx beams.

In one or more implementations, the base station 102 explicitly requests beam information from the UE 104 in an RRC_INACTIVE state performing an SDT session. To facilitate DL Tx beam selection at the base station 102 side, DL beam information reporting would be beneficial where the UE 104 would report, e.g., a candidate serving beam (or a set of candidate serving beams) for the transmission of control and data. The UE 104 may select one or more candidate serving beams based on the DL reception quality or signal level such as measured L1-RSRP or SS-RSRP.

In one or more implementations, the explicit request is signaled within a physical DCI, e.g., PDCCH. In one example the request is indicated by a one-bit field in the PDCCH ordering the UE 104 to provide beam information. In one or more implementations the channel state information (CSI) request field and/or a sounding reference signal (SRS) request field is re-used to indicate the beam information reporting request. Additionally or alternatively, the field within the DCI is present only if the UE 104 monitoring the DCI format is configured with SDT transmissions in at least one of UL or DL direction. In one example, the UE 104 triggers the transmission of beam information in response to receiving such a beam information request signaling from the base station 102.

In one or more implementations, the beam information is a MAC CE which carries the one or more identifier/index of the SSB/beam(s) which the UE 104 selected during SSB selection. In one example, during SSB selection the UE 104 may select one of the SSBs with SS-RSRP above a configured threshold. Additionally or alternatively, the MAC CE may carry information about the evaluation of the candidate beams according to requirements which are, for example, specified elsewhere, such as in TS38.133 which the UE 104 has completed. Generally, the UE 104 provides information of candidate beams based on the SSB evaluation. In one example the UE 104 provides the measured L1-RSRP and the associated index/identifier of the SSB/beam within a MAC CE.

In one or more implementations, the base station 102 indicates whether the UE 104 is to report only the best beam, e.g. one selected SSB or a set of SSBs which are suitable (SSBs with an SS-RSRP above a configured threshold), i.e. candidate Tx beams. This indication may be in one example done by means of a field in the DCI which indicates the two states for beam information reporting. In an example, the field set to ‘1’ indicates that the transmitter shall report the identity/identifier of the selected beam (best DL Tx beam), e.g. one of the SSB(s) with RSRP above a preconfigured threshold. In an example, the field set to ‘0’ indicates that the transmitter shall report a set of suitable beam/SSB(s), e.g. identity/ID of the SSB(s) with an RSRP above a preconfigured threshold. In an example a combination of existing fields within the DCI set to a specific value indicates that the UE 104 shall report DL Tx beam information to the NW (e.g., the base station 102), e.g., best beam or set of suitable beams. In an example a reserved codepoint of an existing field in a DCI indicates that the transmitter shall report DL Tx beam information. In one specific example the ‘CSI request’ field or the ‘SRS request’ field indicates the DL beam information report request. In one specific example a field in the DCI indicates if and for how many suitable beams the DL beam information is requested; for example, a first state of the field indicates no request, a second state indicates a request to report the best beam, a third state indicates a request to report a pre-determined number of best beams, and a fourth state indicates a request to report all beams where an RSRP exceeds a pre-configured threshold level (sdt-RSRP-Threshold). In one implementation a set of Beams are reported when the best beam is below a RSRP/RSRQ threshold. In this implementation it is sufficient to configure this threshold and further indication as to reporting of best beam only or set of beam is not required.

Additionally or alternatively, the base station 102 explicitly requests beam information from the UE 104 in an RRC_INACTIVE state by ordering a RACH procedure. In response to receiving such a beam information reporting request from the base station 102, the UE 104 initiates a random access procedure (also referred to as a RACH session), e.g., a legacy RACH procedure or a RACH-SDT procedure. During the random access procedure the UE 104 provides the beam information by the selection of the RACH preamble/resource information on the selected SSB (of the selected beam) to the base station 102. In one or more implementations, the explicit request is signaled within a physical DCI, e.g., PDCCH. In one example the request is indicated by a one-bit field in the PDCCH ordering the UE 104 to provide beam information by initiating a RACH procedure. In one example the field within the DCI indicating the request is present only if the UE 104 monitoring the DCI format is configured with SDT transmissions in at least one of UL or DL direction. Additionally or alternatively, the CSI request field and/or a SRS request field is re-used to indicate the beam info reporting request by initiation of a RACH procedure. In another example the “PDCCH order” is used to trigger a random access in the UE 104. In the legacy RACH procedure this mechanism is primarily intended for a case when the UE 104 is in the RRC_CONNECTED state and if the base station 102 detects that there is downlink data to be transmitted to the UE 104 and the UE 104 is not uplink synchronized. In one or more implementations, the base station 102 transmits a PDCCH order on the most recently used beam for DL transmission to the UE 104. Additionally or alternatively, the base station 102 transmits a PDCCH order using the most recent beam that was used to transmit a PDCCH and/or corresponding PDSCH to the UE 104. The UE 104 receives the PDCCH order and triggers, e.g., a contention free RACH (CFRA) or CBRA. The PDCCH order is for example sent via DCI Format 1_0 and is scrambled with C-RNTI. The PDCCH order might be, e.g., sent on the dedicated search space or CORESET for DCI Format 1_0. In one example a field in the DCI used for the “PDCCH order” indicates if and for how many suitable beams the DL beam information is requested; for example, a first state of the field indicates no request, a second state indicates a request to report the best beam, a third state indicates a request to report a pre-determined number of best beams, and a fourth state indicates a request to report all beams where an RSRP exceeds a configured threshold level (sdt-RSRP-Threshold).

In one or more implementations, the UE 104 provides location information (e.g., geographic location information) to the base station 102 while being in the RRC_INACTIVE state. The location information is transmitted by using an SDT session. This location information can be provided in place of, or in addition to, the beam information. For example, the beam information may include location information, which implicitly identifies one or more beams as discussed below.

Based on the provided location information of the UE 104, the NW (e.g., the base station 102 or the core network 106) network knows the location of the UE 104 (e.g., a sensor device on a factory floor or a vending machine). The network has an internal database or record that maps a location to a set of transmit beams. This database or record is optionally generated by the UE 104s reporting beam information together with their location information, e.g., whenever the UE 104 reports some beam information the UE 104 also reports its location. The NW uses, based on this database or record, the corresponding beams to reach the UE 104. For example, the base station 102 uses a certain set of beams to page the UE 104 (transmitting PDCCH addressed to the P-RNTI and/or corresponding PDSCH carrying the paging record). In one or more implementations, the UE 104 triggers an SDT session for the reporting of location information while being in the RRC_INACTIVE state. In order to avoid transitioning to the RRC_CONNECTED state for the transmission of the location report, the UE 104 initiates an SDT procedure for the location information reporting. The location information may be signaled via a MAC CE or via higher layer signaling, e.g., RRC signaling. If the UE 104 location changes, the UE 104 informs the NW of this intra-cell mobility, i.e., get a new fix calculated and reports the fix to the base station 102.

The base station 102 receives the beam information from the UE 104 and uses the beam information for subsequent data transmissions to the UE. The base station 102 uses the beam information in any of a variety of public or proprietary manners. For example, the base station 102 may use a serving beam identified in the beam information for subsequent data transmission, e.g., paging messages, to the UE 104.

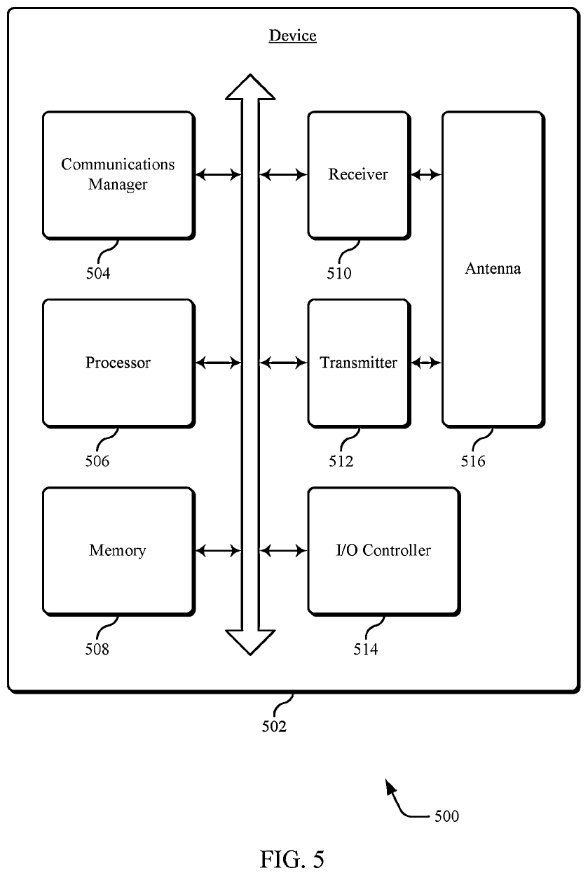

FIG. 5 illustrates an example of a block diagram 500 of a device 502 that supports beam management in an inactive state in accordance with aspects of the present disclosure. The device 502 may be an example of a UE 104 as described herein. The device 502 may support wireless communication with one or more base stations 102, UEs 104, or any combination thereof. The device 502 may include components for bi-directional communications including components for transmitting and receiving communications, such as a communications manager 504, a processor 506, a memory 508, a receiver 510, a transmitter 512, and an I/O controller 514. These components may be in electronic communication or otherwise coupled (e.g., operatively, communicatively, functionally, electronically, electrically) via one or more interfaces (e.g., buses).

The communications manager 504, the receiver 510, the transmitter 512, or various combinations thereof or various components thereof may be examples of means for performing various aspects of the present disclosure as described herein. For example, the communications manager 504, the receiver 510, the transmitter 512, or various combinations or components thereof may support a method for performing one or more of the functions described herein.

In some implementations, the communications manager 504, the receiver 510, the transmitter 512, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 506 and the memory 508 coupled with the processor 506 may be configured to perform one or more of the functions described herein (e.g., by executing, by the processor 506, instructions stored in the memory 508).

Additionally or alternatively, in some implementations, the communications manager 504, the receiver 510, the transmitter 512, or various combinations or components thereof may be implemented in code (e.g., as communications management software or firmware) executed by the processor 506. If implemented in code executed by the processor 506, the functions of the communications manager 504, the receiver 510, the transmitter 512, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 504 may be configured to perform various operations (e.g., receiving, monitoring, transmitting) using or otherwise in cooperation with the receiver 510, the transmitter 512, or both. For example, the communications manager 504 may receive information from the receiver 510, send information to the transmitter 512, or be integrated in combination with the receiver 510, the transmitter 512, or both to receive information, transmit information, or perform various other operations as described herein. Although the communications manager 504 is illustrated as a separate component, in some implementations, one or more functions described with reference to the communications manager 504 may be supported by or performed by the processor 506, the memory 508, or any combination thereof. For example, the memory 508 may store code, which may include instructions executable by the processor 506 to cause the device 502 to perform various aspects of the present disclosure as described herein, or the processor 506 and the memory 508 may be otherwise configured to perform or support such operations.

For example, the communications manager 504 may support wireless communication at a device (e.g., the device 502, a UE) in accordance with examples as disclosed herein. The communications manager 504 and/or other device components may be configured as or otherwise support an apparatus, such as a UE, including a transmitter; and a processor coupled to the transmitter, the processor and the transmitter configured to cause, while the apparatus is in a radio resource control inactive state the apparatus to: trigger generation of beam information for a base station, the beam information indicating a new serving beam; generate the beam information; and transmit the beam information to the base station as part of a small data transmission session.

Additionally, the apparatus (e.g., a UE) includes any one or combination of: the new serving beam including a serving beam on which a paging message is to be received from the base station; a where the processor and the transmitter are further configured to cause the apparatus to determine to trigger generation of the beam information in response to a current serving beam for receiving paging messages from the base station having changed; where to transmit the beam information to the base station is to transmit the beam information to the base station using an uplink of the small data transmission session; where the processor and the transmitter are further configured to cause the apparatus to detect that the current serving beam has changed by measuring a reference signal received power of a most recently received synchronization signal block of the current serving beam, comparing the reference signal received power of the most recently received synchronization signal block to the reference signal received power of an immediately previous most recently received synchronization signal block of the current serving beam, and detecting that the current serving beam has changed if the reference signal received power of the most recently received synchronization signal block is at least a threshold amount less than the reference signal received power of the immediately previous most recently received synchronization signal block; where the processor and the transmitter are further configured to cause the apparatus to detect the change by measuring one or more reference signals prior to monitoring a physical downlink control channel addressed to a paging radio network temporary identifier within a control resource set at a paging occasion defined for the apparatus; where the apparatus further comprises a receiver, the processor and the receiver are configured to cause the apparatus to receive a request from the base station for the beam information, and where to trigger generation and transmission of the beam information is to trigger generation of the beam information in response to the request from the base station; where the request from the base station is a request for the apparatus to initiate a random access channel procedure, and where to transmit the beam information is to transmit the beam information to the base station as part of a random access channel small data transmission session; where the beam information comprises geographic location information; where the beam information includes a channel state information reference signal index of the new serving beam; where the beam information includes a synchronization signal block index of the new serving beam; where the processor and the transmitter are further configured to cause the apparatus to initiate, in response to triggering generation of the beam information or in response to generating the beam information, the small data transmission session.

The communications manager 504 and/or other device components may be configured as or otherwise support a means for wireless communication at a UE, including triggering, while in a radio resource control inactive state, generation of beam information for a base station, the beam information indicating a new serving beam; generating, while in the radio resource control inactive state, the beam information; and transmitting, while in the radio resource control inactive state, the beam information to the base station as part of a small data transmission session.

Additionally, wireless communication at the UE includes any one or combination of: the new serving beam including a serving beam on which a paging message is to be received from the base station; where the triggering comprises triggering generation of the beam information in response to a current serving beam for receiving paging messages from the base station having changed; where the transmitting comprises transmitting the beam information to the base station using an uplink of the small data transmission session; further including: detecting that the current serving beam has changed by measuring a reference signal received power of a most recently received synchronization signal block of the current serving beam; comparing the reference signal received power of the most recently received synchronization signal block to the reference signal received power of an immediately previous most recently received synchronization signal block of the current serving beam; and detecting that the current serving beam has changed if the reference signal received power of the most recently received synchronization signal block is at least a threshold amount less than the reference signal received power of the immediately previous most recently received synchronization signal block; further including detecting that the current serving beam has changed by measuring one or more reference signals prior to monitoring a physical downlink control channel addressed to a paging radio network temporary identifier within a control resource set at a paging occasion defined for the user equipment; further including receiving a request from the base station for the beam information, and the triggering comprises triggering generation of the beam information in response to the request from the base station; where the request from the base station is a request for the user equipment to initiate a random access channel procedure, and the transmitting comprises transmitting the beam information to the base station as part of a random access channel small data transmission session; where the beam information comprises geographic location information; where the beam information includes a channel state information reference signal index of the new serving beam; where the beam information includes a synchronization signal block index of the new serving beam; further including initiating, in response to triggering generation of the beam information or in response to generating the beam information, the small data transmission session.

The processor 506 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 506 may be configured to operate a memory array using a memory controller. In some other implementations, a memory controller may be integrated into the processor 506. The processor 506 may be configured to execute computer-readable instructions stored in a memory (e.g., the memory 508) to cause the device 502 to perform various functions of the present disclosure.

The memory 508 may include random access memory (RAM) and read-only memory (ROM). The memory 508 may store computer-readable, computer-executable code including instructions that, when executed by the processor 506 cause the device 502 to perform various functions described herein. The code may be stored in a non-transitory computer-readable medium such as system memory or another type of memory. In some implementations, the code may not be directly executable by the processor 506 but may cause a computer (e.g., when compiled and executed) to perform functions described herein. In some implementations, the memory 508 may include, among other things, a basic I/O system (BIOS) which may control basic hardware or software operation such as the interaction with peripheral components or devices.

The I/O controller 514 may manage input and output signals for the device 502. The I/O controller 514 may also manage peripherals not integrated into the device 502. In some implementations, the I/O controller 514 may represent a physical connection or port to an external peripheral. In some implementations, the I/O controller 514 may utilize an operating system such as iOS®, ANDROID®, MS-DOS®, MS-WINDOWS®, OS/2®, UNIX®, LINUX®, or another known operating system. In some implementations, the I/O controller 514 may be implemented as part of a processor, such as the processor 506. In some implementations, a user may interact with the device 502 via the I/O controller 514 or via hardware components controlled by the I/O controller 514.

In some implementations, the device 502 may include a single antenna 516. However, in some other implementations, the device 502 may have more than one antenna 516, which may be capable of concurrently transmitting or receiving multiple wireless transmissions. The receiver 510 and the transmitter 512 may communicate bi-directionally, via the one or more antennas 516, wired, or wireless links as described herein. For example, the receiver 510 and the transmitter 512 may represent a wireless transceiver and may communicate bi-directionally with another wireless transceiver. The transceiver may also include a modem to modulate the packets, to provide the modulated packets to one or more antennas 516 for transmission, and to demodulate packets received from the one or more antennas 516.

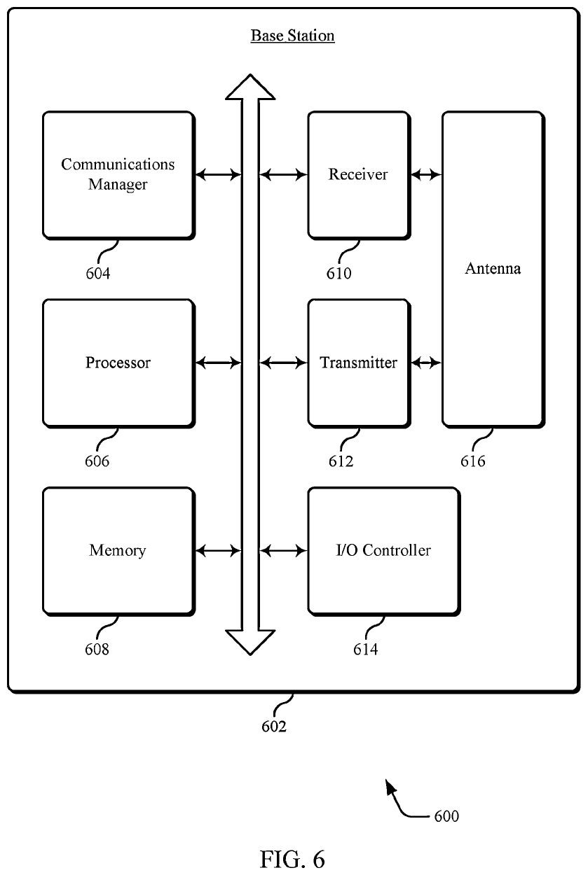

FIG. 6 illustrates an example of a block diagram 600 of a device 602 that supports beam management in an inactive state in accordance with aspects of the present disclosure. The device 602 may be an example of a base station 102, such as a gNB as described herein. The device 602 may support wireless communication and/or network signaling with one or more base stations 102, UEs 104, core network 106, or any combination thereof. The device 602 may include components for bi-directional communications including components for transmitting and receiving communications, such as a communications manager 604, a processor 606, a memory 608, a receiver 610, a transmitter 612, and an I/O controller 614. These components may be in electronic communication or otherwise coupled (e.g., operatively, communicatively, functionally, electronically, electrically) via one or more interfaces (e.g., buses).

The communications manager 604, the receiver 610, the transmitter 612, or various combinations thereof or various components thereof may be examples of means for performing various aspects of the present disclosure as described herein. For example, the communications manager 604, the receiver 610, the transmitter 612, or various combinations or components thereof may support a method for performing one or more of the functions described herein.

In some implementations, the communications manager 604, the receiver 610, the transmitter 612, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 606 and the memory 608 coupled with the processor 606 may be configured to perform one or more of the functions described herein (e.g., by executing, by the processor 606, instructions stored in the memory 608).

Additionally or alternatively, in some implementations, the communications manager 604, the receiver 610, the transmitter 612, or various combinations or components thereof may be implemented in code (e.g., as communications management software or firmware) executed by the processor 606. If implemented in code executed by the processor 606, the functions of the communications manager 604, the receiver 610, the transmitter 612, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 604 may be configured to perform various operations (e.g., receiving, monitoring, transmitting) using or otherwise in cooperation with the receiver 610, the transmitter 612, or both. For example, the communications manager 604 may receive information from the receiver 610, send information to the transmitter 612, or be integrated in combination with the receiver 610, the transmitter 612, or both to receive information, transmit information, or perform various other operations as described herein. Although the communications manager 604 is illustrated as a separate component, in some implementations, one or more functions described with reference to the communications manager 604 may be supported by or performed by the processor 606, the memory 608, or any combination thereof. For example, the memory 608 may store code, which may include instructions executable by the processor 606 to cause the device 602 to perform various aspects of the present disclosure as described herein, or the processor 606 and the memory 608 may be otherwise configured to perform or support such operations.

For example, the communications manager 604 may support wireless communication at a device (e.g., the device 602, base station) in accordance with examples as disclosed herein. The communications manager 604 and/or other device components may be configured as or otherwise support an apparatus, such as a base station, including a transceiver; and a processor coupled to the transceiver, the processor and the transceiver configured to cause the apparatus to: receive beam information from a user equipment while the user equipment is in a radio resource control inactive state, the beam information indicating a new serving beam; and use the beam information for subsequent transmissions to the user equipment.

Additionally, the apparatus (e.g., a base station) includes any one or combination of: where to receive the beam information from the user equipment is to receive the beam information from the user equipment using an uplink of a small data transmission session; where the processor and the transceiver are further configured to cause the apparatus to transmit, to the user equipment, a request for the user equipment to generate the beam information, and where to receive the beam information is to receive the beam information from the user equipment in response to the request; where the request is a request for the user equipment to initiate a random access channel procedure, and where to receive the beam information is to receive the beam information from the user equipment as part of a random access channel small data transmission session; where the beam information includes geographic location information; where the beam information includes a channel state information reference signal index of the new serving beam; where the beam information includes a synchronization signal block index of the new serving beam; where the subsequent transmissions include paging messages.

The communications manager 604 and/or other device components may be configured as or otherwise support a means for wireless communication at a base station, including receiving beam information from a user equipment while the user equipment is in a radio resource control inactive state, the beam information indicating a new serving beam; and using the beam information for subsequent transmissions to the user equipment.

Additionally, wireless communication at the UE includes any one or combination of: where the subsequent transmissions include paging messages; the receiving the beam information from the user equipment including receiving the beam information from the user equipment using an uplink of a small data transmission session; further including transmitting, to the user equipment, a request for the user equipment to generate the beam information, and the receiving including receiving the beam information from the user equipment in response to the request; where the request is a request for the user equipment to initiate a random access channel procedure, and the receiving comprises receiving the beam information from the user equipment as part of a random access channel small data transmission session; where the beam information includes geographic location information; where the beam information includes a channel state information reference signal index of the new serving beam; where the beam information includes a synchronization signal block index of the new serving beam.

The processor 606 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 606 may be configured to operate a memory array using a memory controller. In some other implementations, a memory controller may be integrated into the processor 606. The processor 606 may be configured to execute computer-readable instructions stored in a memory (e.g., the memory 608) to cause the device 602 to perform various functions of the present disclosure.

The memory 608 may include random access memory (RAM) and read-only memory (ROM). The memory 608 may store computer-readable, computer-executable code including instructions that, when executed by the processor 606 cause the device 602 to perform various functions described herein. The code may be stored in a non-transitory computer-readable medium such as system memory or another type of memory. In some implementations, the code may not be directly executable by the processor 606 but may cause a computer (e.g., when compiled and executed) to perform functions described herein. In some implementations, the memory 608 may include, among other things, a basic I/O system (BIOS) which may control basic hardware or software operation such as the interaction with peripheral components or devices.

The I/O controller 614 may manage input and output signals for the device 602. The I/O controller 614 may also manage peripherals not integrated into the device 602. In some implementations, the I/O controller 614 may represent a physical connection or port to an external peripheral. In some implementations, the I/O controller 614 may utilize an operating system such as iOS®, ANDROID®, MS-DOS®, MS-WINDOWS®, OS/2®, UNIX®, LINUX®, or another known operating system. In some implementations, the I/O controller 614 may be implemented as part of a processor, such as the processor 606. In some implementations, a user may interact with the device 602 via the I/O controller 614 or via hardware components controlled by the I/O controller 614.

In some implementations, the device 602 may include a single antenna 616. However, in some other implementations, the device 602 may have more than one antenna 616, which may be capable of concurrently transmitting or receiving multiple wireless transmissions. The receiver 610 and the transmitter 612 may communicate bi-directionally, via the one or more antennas 616, wired, or wireless links as described herein. For example, the receiver 610 and the transmitter 612 may represent a wireless transceiver and may communicate bi-directionally with another wireless transceiver. The transceiver may also include a modem to modulate the packets, to provide the modulated packets to one or more antennas 616 for transmission, and to demodulate packets received from the one or more antennas 616.

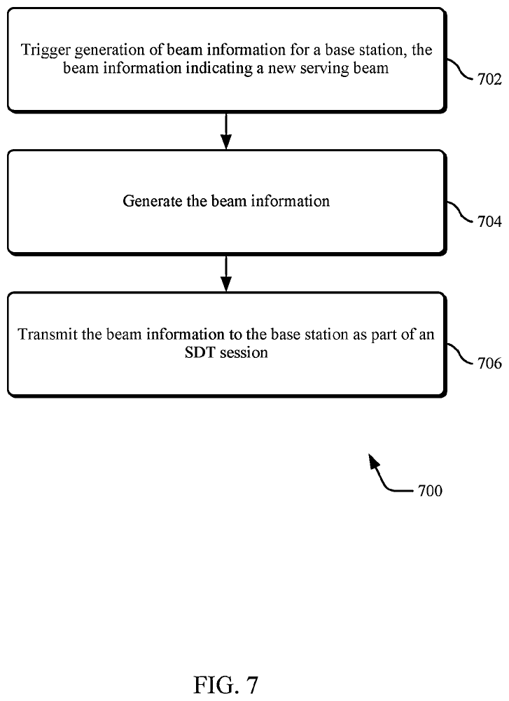

FIG. 7 illustrates a flowchart of a method 700 that supports beam management in an inactive state in accordance with aspects of the present disclosure. The operations of the method 700 may be implemented by a device or its components as described herein. For example, the operations of the method 700 may be performed by a device, such as UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 702, the method may include triggering generation of beam information for a base station, the beam information indicating a new serving beam. The operations of 702 may be performed in accordance with examples as described herein. In some implementations, aspects of the operations of 702 may be performed by a device as described with reference to FIG. 1.

At 704, the method may include generating the beam information. The operations of 704 may be performed in accordance with examples as described herein. In some implementations, aspects of the operations of 704 may be performed by a device as described with reference to FIG. 1.

At 706, the method may include transmitting the beam information to the base station as part of an SDT session. The operations of 706 may be performed in accordance with examples as described herein. In some implementations, aspects of the operations of 706 may be performed by a device as described with reference to FIG. 1.

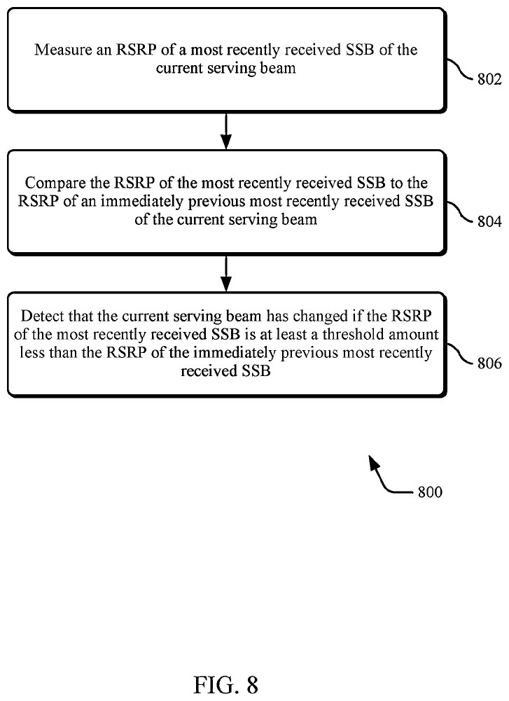

FIG. 8 illustrates a flowchart of a method 800 that supports beam management in an inactive state in accordance with aspects of the present disclosure. The operations of the method 800 may be implemented by a device or its components as described herein. For example, the operations of the method 800 may be performed by a base station 102, such as a gNB as described with reference to FIGS. 1 through 6. In some implementations, the device may execute a set of instructions to control the function elements of the device to perform the described functions. Additionally, or alternatively, the device may perform aspects of the described functions using special-purpose hardware.

At 802, the method may include measuring an RSRP of a most recently received SSB of the current serving beam. The operations of 802 may be performed in accordance with examples as described herein. In some implementations, aspects of the operations of 802 may be performed by a device as described with reference to FIG. 1.

At 804, the method may include comparing the RSRP of the most recently received SSB to the RSRP of an immediately previous most recently received SSB of the current serving beam. The operations of 804 may be performed in accordance with examples as described herein. In some implementations, aspects of the operations of 804 may be performed by a device as described with reference to FIG. 1.

At 806, the method may include detecting that the current serving beam has changed if the RSRP of the most recently received SSB is at least a threshold amount less than the RSRP of the immediately previous most recently received SSB. The operations of 806 may be performed in accordance with examples as described herein. In some implementations, aspects of the operations of 806 may be performed by a device as described with reference to FIG. 1.

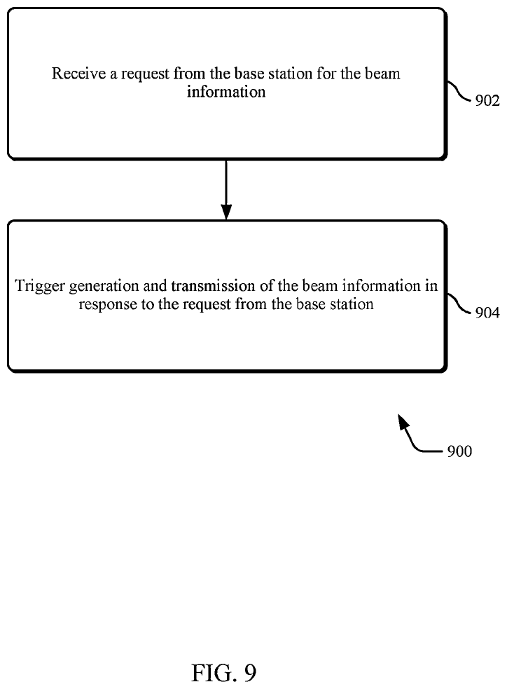

FIG. 9 illustrates a flowchart of a method 900 that supports beam management in an inactive state in accordance with aspects of the present disclosure. The operations of the method 900 may be implemented by a device or its components as described herein. For example, the operations of the method 900 may be performed by a base station 102, such as a gNB as described with reference to FIGS. 1 through 6. In some implementations, the device may execute a set of instructions to control the function elements of the device to perform the described functions. Additionally, or alternatively, the device may perform aspects of the described functions using special-purpose hardware.

At 902, the method may include receiving a request from the base station for the beam information. The operations of 902 may be performed in accordance with examples as described herein. In some implementations, aspects of the operations of 902 may be performed by a device as described with reference to FIG. 1.

At 904, the method may include triggering generation and transmission of the beam information in response to the request from the base station. The operations of 904 may be performed in accordance with examples as described herein. In some implementations, aspects of the operations of 904 may be performed by a device as described with reference to FIG. 1.

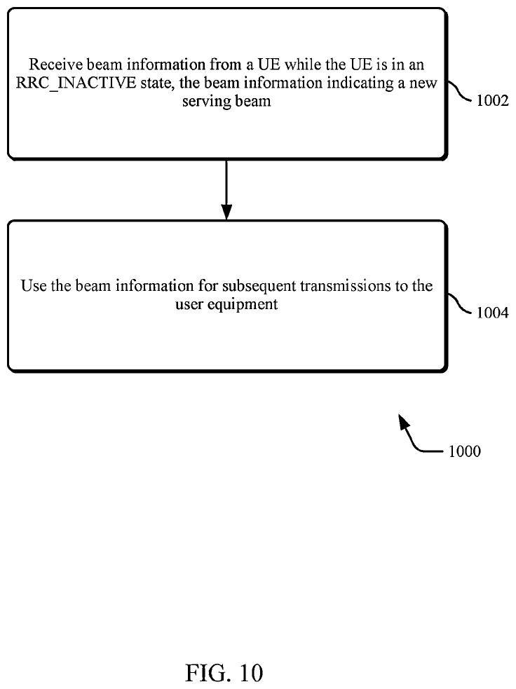

FIG. 10 illustrates a flowchart of a method 1000 that supports beam management in an inactive state in accordance with aspects of the present disclosure. The operations of the method 1000 may be implemented by a device or its components as described herein. For example, the operations of the method 1000 may be performed by a base station 102, such as a gNB as described with reference to FIGS. 1 through 6. In some implementations, the device may execute a set of instructions to control the function elements of the device to perform the described functions. Additionally, or alternatively, the device may perform aspects of the described functions using special-purpose hardware.

At 1002, the method may include receiving beam information from a UE while the UE is in an RRC_INACTIVE state, the beam information indicating a new serving beam. The operations of 1002 may be performed in accordance with examples as described herein. In some implementations, aspects of the operations of 1002 may be performed by a device as described with reference to FIG. 1.

At 1004, the method may include using the beam information for subsequent transmissions to the user equipment. The operations of 1004 may be performed in accordance with examples as described herein. In some implementations, aspects of the operations of 1004 may be performed by a device as described with reference to FIG. 1.

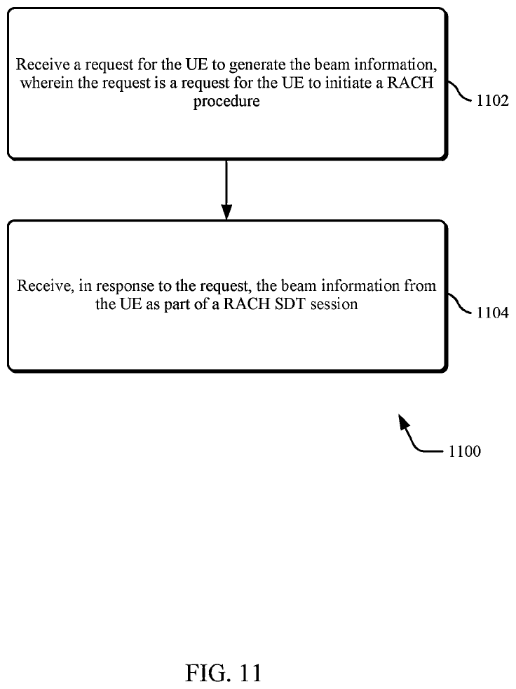

FIG. 11 illustrates a flowchart of a method 1100 that supports beam management in an inactive state in accordance with aspects of the present disclosure. The operations of the method 1100 may be implemented by a device or its components as described herein. For example, the operations of the method 1100 may be performed by a base station 102, such as a gNB as described with reference to FIGS. 1 through 6. In some implementations, the device may execute a set of instructions to control the function elements of the device to perform the described functions. Additionally, or alternatively, the device may perform aspects of the described functions using special-purpose hardware.

At 1102, the method may include receiving a request for the UE to generate the beam information, wherein the request is a request for the UE to initiate a RACH procedure. The operations of 1102 may be performed in accordance with examples as described herein. In some implementations, aspects of the operations of 1102 may be performed by a device as described with reference to FIG. 1.

At 1104, the method may include receiving, in response to the request, the beam information from the UE as part of a RACH SDT session. The operations of 1104 may be performed in accordance with examples as described herein. In some implementations, aspects of the operations of 1104 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled to the at least one memory and configured to cause, while the UE is in a radio resource control inactive state, the UE to:
trigger generation of beam information for a base station, the beam information indicating a new serving beam;
generate the beam information; and
transmit the beam information to the base station as part of a small data transmission session.

2. The UE of claim 1, the new serving beam comprising a serving beam on which a paging message is to be received from the base station.

3. The UE of claim 1, wherein the at least one processor is further configured to cause the UE to determine to trigger generation of the beam information in response to a current serving beam for receiving paging messages from the base station having changed.

4. The UE of claim 3, wherein to transmit the beam information to the base station is to transmit the beam information to the base station using an uplink of the small data transmission session.

5. The UE of claim 3, wherein the at least one processor is further configured to cause the UE to detect that the current serving beam has changed by measuring a reference signal received power of a most recently received synchronization signal block of the current serving beam, comparing the reference signal received power of the most recently received synchronization signal block to the reference signal received power of an immediately previous most recently received synchronization signal block of the current serving beam, and detecting that the current serving beam has changed if the reference signal received power of the most recently received synchronization signal block is at least a threshold amount less than the reference signal received power of the immediately previous most recently received synchronization signal block.

6. The UE of claim 3, wherein the at least one processor is further configured to cause the UE to detect the change by measuring one or more reference signals prior to monitoring a physical downlink control channel addressed to a paging radio network temporary identifier within a control resource set at a paging occasion defined for the UE.

7. The UE of claim 1, wherein the at least one processor is further configured to cause the UE to receive a request from the base station for the beam information, and wherein to trigger generation of the beam information is to trigger generation and transmission of the beam information in response to the request from the base station.

8. The UE of claim 7, wherein the request from the base station is a request for the UE to initiate a random access channel procedure, and wherein to transmit the beam information is to transmit the beam information to the base station as part of a random access channel small data transmission session.

9. The UE of claim 1, wherein the beam information comprises geographic location information.

10. The UE of claim 1, wherein the beam information includes a channel state information reference signal index of the new serving beam.

11. The UE of claim 1, wherein the beam information includes a synchronization signal block index of the new serving beam.

12. The UE of claim 1, wherein the at least one processor is further configured to cause the UE to initiate, in response to triggering generation of the beam information or in response to generating the beam information, the small data transmission session.

13. A base station for wireless communication, comprising:
at least one memory; and
at least one processor coupled with the at least one memory and configured to cause the base station to:
receive beam information from a user equipment (UE) while the UE is in a radio resource control inactive state, the beam information indicating a new serving beam; and
use the beam information for subsequent transmissions to the UE.

14. The base station of claim 13, wherein to receive the beam information from the UE is to receive the beam information from the UE using an uplink of a small data transmission session.

15. The base station of claim 13, wherein the at least one processor is further configured to cause the base station to transmit, to the UE, a request for the UE to generate the beam information, and wherein to receive the beam information is to receive the beam information from the UE in response to the request.

16. The base station of claim 15, wherein the request is a request for the UE to initiate a random access channel procedure, and wherein to receive the beam information is to receive the beam information from the UE as part of a random access channel small data transmission session.

17. (canceled)

18. (canceled)

19. (canceled)

20. A method performed by a user equipment (UE), the method comprising:
triggering, while in a radio resource control inactive state, generation of beam information for a base station, the beam information indicating a new serving beam;
generating, while in the radio resource control inactive state, the beam information; and
transmitting, while in the radio resource control inactive state, the beam information to the base station as part of a small data transmission session.

21. A processor for wireless communication, comprising:
at least one controller coupled with at least one memory and configured to cause, while the processor is in a radio resource control inactive state, the processor to:
trigger generation of beam information for a base station, the beam information indicating a new serving beam;
generate the beam information; and
transmit the beam information to the base station as part of a small data transmission session.

22. The processor of claim 21, the new serving beam comprising a serving beam on which a paging message is to be received from the base station.

23. The processor of claim 21, wherein the at least one controller is further configured to cause the processor to determine to trigger generation of the beam information in response to a current serving beam for receiving paging messages from the base station having changed.
